(19) United States
(12) Patent Application Publication
(10) Pub. No.: US 2019/0304022 A1
(43) Pub. Date: Oct. 3, 2019

(54) WORKERS COMPENSATION GOLD RESOLUTION METHOD

(71) Applicant: Paul Gold, Hillsborough, NJ (US)

(72) Inventor: Paul Gold, Hillsborough, NJ (US)

(21) Appl. No.: 15/937,821

(22) Filed: Mar. 27, 2018

(51) Int. Cl. G06Q 40/08; G06Q 10/10

(52) U.S. Cl. CPC G06Q 40/08; G06Q 10/1095

(57) ABSTRACT

The system and method for reducing the costs and time requirements associated with workers' compensation claims by introducing a proprietary claims-resolution method disclosed herein may comprise the use of one-day settlement conferences to resolve outstanding claims. Such handling of workers' compensation claims may employ specially-trained consultants who approach such claims in a novel way. Especially important to the present method is the abandoning of Insurer reserve marks, and the impartial analyzing to claims to achieve a mutually beneficial settlement agreement. Such a method may be made available in a plurality of states, and may be locally modified to maintain compliance with workers' compensation settlement requirements of certain jurisdictions.

### PRIORITY NOTICE

The present application makes no claims of priority under 35 U.S.C. § 119(e) to any U.S. Provisional Patent Applications.

### CROSS REFERENCE TO RELATED PATENT APPLICATIONS

The present application makes no reference to any other related filed patent applications.

### STATEMENT REGARDING FEDERAL SPONSORSHIP

No part of this invention was a result of any federally sponsored research.

### TECHNICAL FIELD OF THE INVENTION

The present invention relates in general to insurance coverage, and, more specifically, to a system and method for reducing the costs and time requirements associated with workers' compensation claims by implementation of a proprietary claims-resolution method.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Workers' compensation is a class of insurance mandated by state and federal governments whereby employers provide employees with medical and disability benefits for illness or injuries incurred in the course and scope of their employment. Unlike other classes of insurance, workers' compensation insurance does not require underwriting criteria such as payroll, number of employees, job classifications, aggregated loss experience, and actuarial modifiers. Insurers and self-insureds typically do not maintain lists of covered employees or documentation that identifies individual covered employees.

Workers' compensation insurance may be obtained from an insurer or may be financed by an employer. At present, insurers see claims through the adjudication process from the arising of a dispute to the obtaining of a final settlement and resolution of said claim. This process may take months to years to completely resolve by the process used in the industry today. The process that exists today usually involves an adjuster and, sometimes, legal counsel, working in conjunction to obtain the settlement. Because the process may drag on for years, the substantial costs of legal fees, multiple independent physician visits, multiple independent medical evaluations, and other costs of prosecuting the claim accrue.

There is a need in the art for a new method of conducting and obtaining workers' compensation settlements in open and ongoing cases that may reduce the insurer's expenses on each specific claim. Such a method may improve upon the management of the claims process in place today by providing the insurer a significantly lower lost-cost expectation than what was originally expected to be achieved. Furthermore, the method may benefit all parties by providing an expedited resolution to the claim, thus awarding needed benefits to the claimant in a timely manner and reducing the work load of the insurer's representatives.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a system and method for reducing the costs and time requirements associated with workers' compensation claims by introducing a proprietary claims-resolution method.

It is an objective of the present invention to provide a system and method for reducing the costs and time requirements associated with workers' compensation claims that may resolve outstanding claims by implementing a one-day settlement conference.

It is another objective of the present invention to provide a system and method for reducing the costs and time requirements associated with workers' compensation claims that may employ specially-trained consultants.

It is another objective of the present invention to provide a system and method for reducing the costs and time requirements associated with workers' compensation claims that may be available nationally, though may implement state-specific rules and requirements when needed.

It is another objective of the present invention to provide a system and method for reducing the costs and time requirements associated with workers' compensation claims that offers contingency fee-based services for Insurers and Third Party Administrators.

It is another objective of the present invention to provide a system and method for reducing the costs and time requirements associated with workers' compensation claims that offers flat fee-based services Insurers and Third Party Administrators.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an overview of a system and method for reducing the costs and time requirements associated with workers' compensation claims.

FIG. 2 illustrates an overview of a first embodiment of a system and method for reducing the costs and time requirements associated with workers' compensation claims.

FIG. 3 illustrates an overview of a second embodiment of a system and method for reducing the costs and time requirements associated with workers' compensation claims.

### DETAILED DESCRIPTION OF THE INVENTION

Certain terminology is used in the following description for reference only and is not limiting. Unless specifically set forth herein, the terms “a,” “an,” and “the” are not limited to one element, but instead should be read as meaning “at least one.”

The present invention relates generally to insurance coverage, and, more specifically, to a system and method for reducing the costs and time requirements associated with workers' compensation claims by implementation of a proprietary claims-resolution method.

Presently, the workers' compensation claims process is expensive, inefficient, and unnecessarily time-consuming. The source of these problems revolves around the archaic claims handling methods that continue to be used. Such methods result in insurance providers (Insurers) and Third-Party Administrators (TPAs) far exceeding their budgets over the course of multiple years, instead of performing a simple examination of the Total Cost of Risk (TCOR) incurred. Strategic management of claims, whether new or long-existing, can have a significant and direct impact on the administrative costs incurred.

Insurers and TPAs tend to employ the same course of action and rarely change their positions once litigation on a disputed claim has begun. This inefficient approach tends to involve the over-utilization of Independent Medical Exams (IMEs) and physician evaluation services and the accumulation of legal fees contributing to a vast array of unnecessary administrative costs. When aiming to settle a case for a specific reserve mark, carriers tend to lose sight of the costs involved in achieving such a mark, and the majority of such claims could be settled at a significantly reduced expense.

As an example, a workers' compensation claim may have been open for nearly three years, and the claimant in such a claim may have already achieved Maximum Medical Improvement (MMI) though with a disputed claim of permanency. The Insurer may have set a reserve mark in this claim at $30,000, though the Claimant may be seeking to settle the claim for $50,000. Often the Insurer in such a matter may take a firm stance on their reserve mark, which continues to generate additional administrative expenses due to continued litigation, and such additional expenses may far exceed the $20,000 difference between the two settlement offers. National average statistics in the workers' compensation industry show that an Insurer often spends approximately $60,000 in administrative costs to achieve the $30,000 reserve mark.

Such administrative costs accrue any time an Insurer offers a less-than-adequate settlement offer. As a claim ages, the Insurer may eventually decide to offer a larger settlement to obtain a release of the claim and eliminate further risk exposure. Such an approach results in a larger initial payment by the Insurer, though reduces the Insurer's overall costs in maintaining the open claim. Introducing the present settlement model early on in the claims process may result in a reduction in overall TCOR for the Insurer.

Such a simplistic approach, though, does not identify the entirety of the existing issues. Long-existing claims often lead to a breakdown in strategy within the Insurer's company, perpetuated by the existing models, and a breakdown in trust between the Claimant and the Insurer. The Claimant may eventually come to see the claims process as a never-ending cycle from which no winners emerge. Such a process may be propagated because Insurers and their attorneys may not have experienced the workers' compensation process from the Claimant's perspective, and cannot truly understand the frustration and difficulty that comes from enduring such an experience.

A more efficient and cost-effective approach to workers' compensation claims may create an environment in which saving money and maintaining trust are mutually beneficial concepts. A common bond must be established between the Claimant and the party with whom they are interacting. Such a bond may lead to the potential for settling the claim quickly or within a single settlement meeting. The objective of such a meeting would be to achieve a satisfactory middle ground for both the Insured and Claimant, and to allow the Claimant to feel they are being heard and helped by someone who has been through an experience similar to theirs. Such an approach may significantly reduce the Insurer's administrative costs and may provide Claimant's with earlier financial relief.

In one embodiment, the present model may be implemented once an evaluation of permanent injury has been completed in the workers' compensation claim. In a second embodiment, the present model may be implemented as early as the onset of the filing of the claim, prior to the determination of MMI, up to within the first 60 to 180 days of the claim, or any time prior to the onset of the litigation stage of the claim. In a third embodiment, the present model may comprise an option for meeting with a future Claimant prior to the filing of their claim, so as to discuss the present model and the Claimant's options for proceeding in this fashion. Such an embodiment may be advantageous over the first two, as it would allow the Claimant to forego entering the current workers' compensation process and may maximize the cost savings to the Insurer.

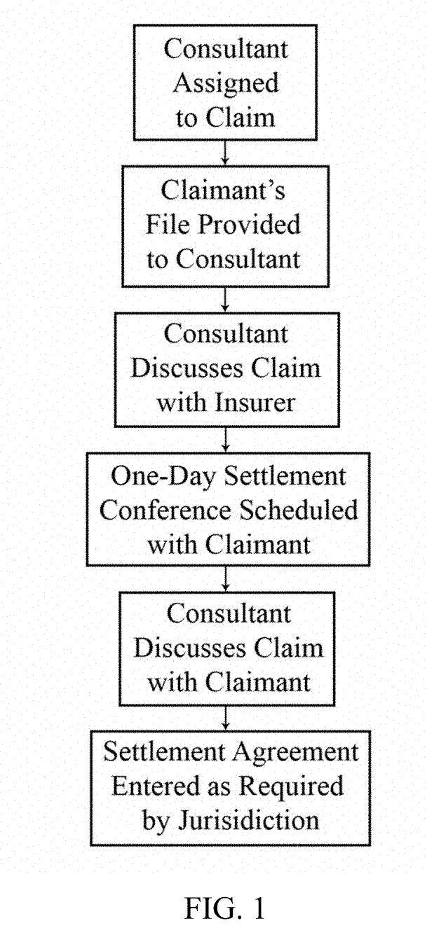

As shown in FIG. 1, a workers' compensation Consultant, who would be neither an Insurer's adjuster nor counsel, but instead may be a specialist trained in the present method, may be assigned the claim. The Insurer may provide a copy of the claim file to the Consultant for review. Such a providing may be performed electronically, and the claim file is preferably provided as a PDF format file. The Consultant may begin the process by reviewing the claim file and consulting with the Insurer to determine the overall status of the claim and to determine an effective settlement offer for the Insurer to give. Such consulting with the Insurer may involve determining the Insurer's future costs on the claim, and assessing the benefit of issuing a larger claim payout in the near term versus administrating the claim over the course of multiple years. Once the review has been completed a one-day settlement conference may be scheduled to discuss the claim with the Claimant. From here the Consultant may consult with the Claimant or Claimant's counsel to determine the details of the claim and to determine the Claimant's position. The Consultant may then work independently to resolve the differences between the Insurer's position and the Claimant's position. Such work may include discussing the Claimant's position with the Insurer and recommending a modified position for the Insurer to accept. Once an amenable resolution has been proposed, the Consultant may again consult with the Insurer to ensure that both parties are satisfied with the proposed resolution. Such a resolution may aim to adequately compensate the Claimant for their claim while achieving a release of liability for the Insurer.

Essential to the present model is the practice of scheduling the one-day settlement at a neutral or out-of-court location. At present, such meetings are generally performed within the court system, on the record, and between counsels for both parties. In the present method the one-day settlement agreement is preferably scheduled at the Consultant's office or Claimant's counsel's office, and off the record. As contemplated by the present method, Claimants that have entered the litigation stage of the claim are preferably represented by counsel. In contrast, Claimants that have not yet entered the litigation stage of the claim may be represented by counsel or may appear pro se.

Also essential to the present model is the practice of abandoning the Insurer's reserve mark when the Consultant is analyzing the value of the claim. The reserve mark usually serves only to increase the costs of litigating the claim in an attempt to achieve the mark. Instead, the Consultant will approach the claim without a predetermined objective, and will be able to then best achieve a mutually beneficially agreement at a minimum of cost.

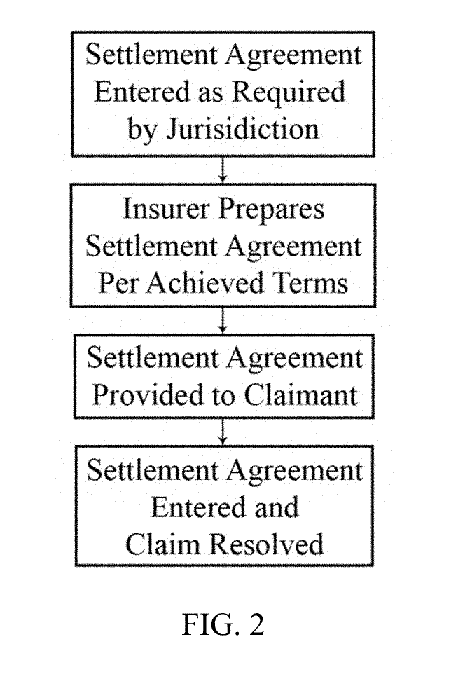

FIG. 2 shows an overview of a first method by which the claim settlement may be entered in the present method. In jurisdictions that do not require a judge or commissioner to enter the claim settlement agreement, the Insurer may send the proposed settlement agreement to the Claimant with the terms that have been achieved through the one-day settlement process. The Claimant may execute this agreement, and the Insurer may be satisfied that the agreement contains its own settlement language and releases.

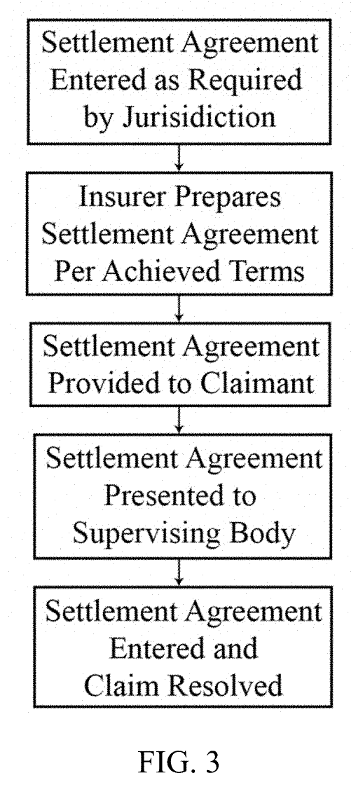

FIG. 3 shows an overview of a second method by which the claim settlement may be entered in the present method. In jurisdictions that do require a judge or commissioner to enter the claim settlement agreement, the one-day settlement meeting may be scheduled within a 72 hours of the next scheduled court hearing so that the agreement may be entered with the court as soon as possible. The Insurer may send the proposed settlement agreement to the Claimant with the terms that have been achieved through the one-day settlement process using language and releases required in the jurisdiction. The proposed settlement agreement may be entered with the court by the Insurer's counsel or the Claimant's counsel, if also required by the jurisdiction.

The costs for the services provided by this method may be compensated in any way that Insurers are most amenable with or in any way required by the jurisdiction. The compensation may be established as a fixed fee project or as a contingency fee project, and such contingency fee may be paid as a percentage of the value of the settlement. The value of the compensation may be determined by the length of time, in months or years, that the claim has remained open. As an example, a certain rate may be applied for claims open between 0 and 4 years, while a different rate may apply to claims open 4 to 7 years, and a third rate may apply for claims open more than 7 years.

The present method may further comprise a video conference that may take place between the Consultant and the Claimant, or the Consultant and the Insurer. The method may further comprise a live or pre-recorded video introduction for the purpose of creating or improving trust between the Consultant and the Claimant. Such a video introduction may run between 2 and 5 minutes, and may introduce the author of the present method and the Consultant, and may relay to the Claimant details of the author's own workers' compensation claim experience. Such a video may create or improve trust within the Claimant as it may relate to the Claimant that the Consultant is familiar with the experience that the Claimant is going through. The present method may further comprise a pre-recorded video that a third-party may implement when attempting to perform the present method under license.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A method for resolving workers' compensation claims, comprising:
contracting with an Insurer;
receiving a Claim Information File regarding a Claim from said Insurer;
assigning a Consultant to review said Claim Information File regarding said Claim;
discussing said Claim with said Insurer;
disregarding a Reserve Mark set by said Insurer;
scheduling a One-Day Settlement Conference with a Claimant of said Claim;
discussing said Claim with said Claimant during said One-Day Settlement Conference;
proposing a Settlement Agreement based on said discussing said Claim with said Claimant during said One-Day Settlement Conference; and
entering said Settlement Agreement as required by a Jurisdiction.

2. The method of claim 1,
wherein said Jurisdiction allows said Settlement Agreement to be entered between said Insurer and said Claimant.

3. The method of claim 1,
wherein said Jurisdiction requires said Settlement Agreement to be entered by a Court Officer.

4. The method of claim 1,
wherein said receiving a Claim Information File regarding a Claim from said Insurer happens during a Litigation Phase of said Claim.

5. The method of claim 1,
wherein said receiving a Claim Information File regarding a Claim from said Insurer happens before a Litigation Phase of said Claim.

6. The method of claim 1,
wherein said receiving a Claim Information File regarding a Claim from said Insurer happens before said Claim is filed.

7. The method of claim 1,
wherein a Consultant's Payment is earned on a Contingency Basis.

8. The method of claim 1,
wherein said Consultant's Payment is earned on a Fixed-Fee Basis.
